(19) United States
(12) Patent Application Publication
(10) Pub. No.: US 2022/0069762 A1
(43) Pub. Date: Mar. 3, 2022

(54) PORTABLE SOLAR POWER SYSTEM

(71) Applicant: Blue Planet Research, LLC, Honolulu, HI (US)

(72) Inventor: Henk B. Rogers, Honolulu, HI (US)

(21) Appl. No.: 17/229,374

(22) Filed: Apr. 13, 2021

Related U.S. Application Data
(60) Provisional application No. 63/070,037, filed on Aug. 25, 2020.

(51) Int. Cl. H02S 10/40; H02S 40/38; H02S 30/10; H02S 30/20

(52) U.S. Cl. CPC H02S 10/40; H02S 30/20; H02S 30/10; H02S 40/38

(57) ABSTRACT

A portable solar power system comprises plural solar panel subarrays suspended by u-shaped connected rods about a container housing a battery bank and other electronics. The system can be rapidly deployed and broken down, and provides a large expanse of substantially continuous light sensitive area in a small space.

### CROSS-REFERENCE TO RELATED APPLICATIONS

This application claims the benefit of U.S. Provisional Patent Application 63/070,037 (Docket No. 5481-9) filed Aug. 25, 2020. This prior application is incorporated herein by reference in its entirety and for all purposes.

### STATEMENT REGARDING FEDERALLY SPONSORED RESEARCH OR DEVELOPMENT

None.

### FIELD

The technology herein relates to solar power, and more particularly to a portable solar power system providing an array of suspended solar panels.

### BACKGROUND AND SUMMARY

With our planet on the way to a population of 10 billion people, we simply cannot waste resources. Humans must make the shift to circular processes. The burning of fossil fuels for energy creates enormous amounts of carbon dioxide as a waste product, with catastrophic consequences. It is essential to eliminate use of carbon-based fuels and power the world with clean, reliable, affordable energy. We need to change the way we power the world and make energy awareness delightful.

Blue Planet Research has pioneered a range of efficient, cost-effective energy storage technologies that use Lithium Ferrous Phosphate cells requiring no maintenance and providing long life. Such storage technologies can be charged by arrays of conventional solar photovoltaic (PV) panels. Solutions are known that mount solar panels to surfaces of a deployed structures. It is also known to deploy solar panels directly on the ground. On ground panels are subject to damage by people and animals

However, there are significant challenges to deploying solar panel arrays in compact arrangements to provide sufficient surface area in portable, mobile, stationary or other non-permanent installations without taking up too much area. Therefore, for military deployments, emergency field operations such as field hospitals and communications posts, field kitchens, and other temporary “off the grid” installations requiring substantial self-power sourcing in a compact space, generators powered by fossil-fuel burning internal combustion engines are generally still the most commonly used power solutions.

Thus, there remains a pressing need for an easily-deployable portable solar power solution that provides a solar panel surface area large enough to power a field hospital, a third world village, a command post, communications post or other temporary installation without taking up excessive area. A normal first world house often uses as much electricity as an entire third world village. A third world village might need just enough power for phones, perhaps some monitors and a communal fridge. There is a long felt but unsolved need to bring power to small islands or remote locations where there is no power.

### BRIEF DESCRIPTION OF THE DRAWINGS

The following detailed description of exemplary non-limiting illustrative embodiments is to be read in conjunction with the drawings of which:

FIG. 1 is a perspective view of an example system including an array of deployed portable solar panels.

FIGS. 2 and 3 show other perspective views of the example system.

FIG. 4 is a birds eye view of an example solar panel array.

FIG. 5 is a top (without roof) view of an example solar power system kit to show the container and its contents.

FIG. 6 is an electrical schematic block diagram of an example solar power system.

FIG. 7 is an electrical schematic circuit diagram of an example solar power system.

FIG. 8 shows an example non-limiting implementation of a solar power system before deployment.

FIGS. 9 & 10 shows an example non-limiting implementation of a deployed solar power system.

FIG. 11 shows how the system can be deployed by helicopter.

FIG. 12 shows how the system can be transported by a fork lift.

### DETAILED DESCRIPTION OF PREFERRED EMBODIMENTS

The technology herein provides a mosaic of solar panels interlocked to form a substantially continuous photosensitive canopy supported by an arrangement of portable lightweight tubular support frames. The resulting structure can be quickly deployed to provide high energy output in a small area.

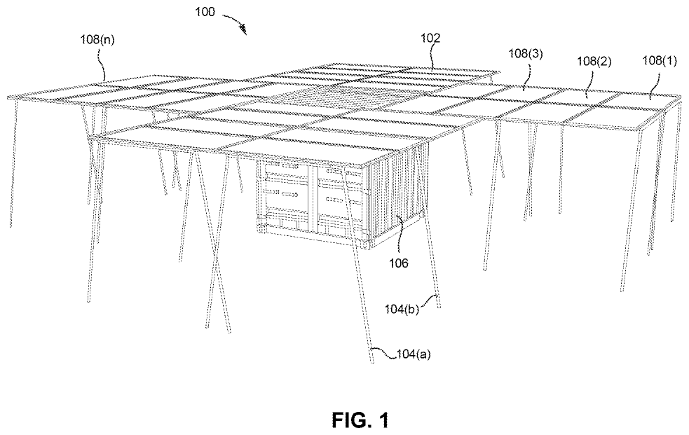

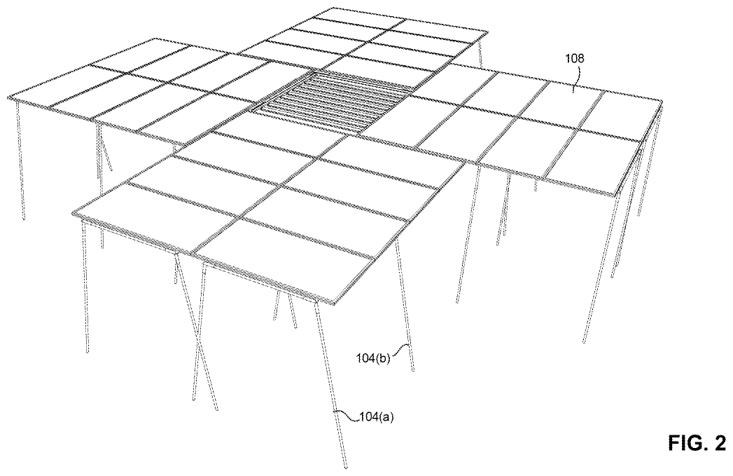

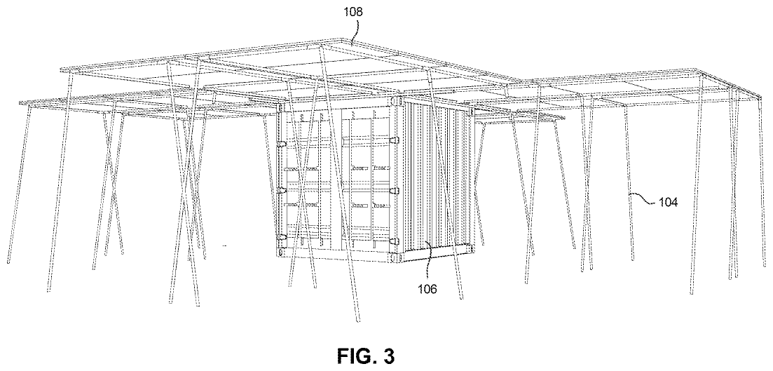

FIGS. 1-3 show different perspective views of an example non-limiting temporary solar power system 100. System 100 includes a solar panel array 102 suspended on a support framework 104. System 100 further includes a housing 106 that contains batteries, electronics, and in a pre-deployed state, the assembled solar panel array 102 and assembled support framework 104.

In the example non-limiting example, the solar panel array 102 comprises plural solar panels 108(1), . . . , 108(n). Each solar panel 108 may comprise a conventional planar, rectangular PV solar panel providing a desired output voltage/current such as 24VDC at 8.3 amps (e.g., ˜400 watts per panel). The number n of panels 108 are determined by the desired voltage and current of the overall system and space available in the container. For example, a system capable of generating 6.4 KW at 48 volts may comprise 32 such panels 108 with each pair of panels connected in series. As those skilled in the art will understand, any number n of panels 108 of any desired configuration may be used to provide a variety of different desired output voltages and/or currents for a particular application(s).

Conventional panels 108 are typically surrounded about their peripheries by metal or other framing components that seal the panels and provide a durable rugged mechanical structure, allowing panels to be joined together in an array. In the example shown, such frames are typically used to allow a number (e.g., 4) of panels 108 to be assembled together into a substantially continuous planar subarray. However, while it is possible to rest an array of panels 108 directly on the surface of the ground, there are problems with such support that make it desirable to suspend the panels above the ground in an efficient manner that does not require extensive additional area and can provide shade.

In example embodiments, such a subarray is supported above the ground by a modular, hollow tubular support frame 104 comprising a pair of U-shaped leg assemblies 104(a), 104(b) —one leg assembly being disposed on each end of each sub-array. Such support frames may provide interlocking tubes of the type often used to construct portable tents, tarps and the like. The support frames may be constructed of hollow or solid metal (e.g., aluminum, steel, etc.) or other relative strong but lightweight material (e.g, carbon graphite).

Such hollow or solid tubes can comprise tube segments with interlocking ends such that larger female components on distal end portions of one tube segment slidably accept smaller male tube ends of one or more interlocking tube segments to form a generally rigid, U-shaped support structure comprising three or more tube segments—e.g., one horizontal, the other two nearly vertical but forming an angle with the horizontal member in the range of 65 degrees to 80 degrees relative to vertical. The distal ends of the nearly vertical side tube segments may terminate in caps, pads or the like so these tube segments can rest on a ground surface without penetrating the ground or taking in sand, dirt, mud or the like. In some other embodiments, the lower ends of the nearly vertical tube segments mate with a further horizontal tube segment some or all of which rests on the ground to provide trapezoidal-shaped support frame structures. See FIG. 10, which also shows the use of pins 402 to retain different tube segments together.

In the embodiment shown, the support structure 104 is not used to hold the panels of a subarray together. Connections between panels are instead provided by other structure such as interlocking pins and holes on the edges of the panels themselves, thereby connecting the panels so they are adjacent to one another. Such interlocking structures are conventionally found in PV solar panels designed for configuration and connection in arrays for use on roof installations, but until now such interlocking structures have not been particularly useful in most portable applications due to the absence of any planar structure for supporting the interlocked panels and disadvantages of deploying panels directly onto the ground surface. The example non-limiting embodiment makes use of such interlocking structures despite the absence of any permanent planar support structures, thereby avoiding the need to modify the solar panels while still maximizing exposure of solar panel surface area to the radiance of the sun. The present embodiments essentially create a flexible mosaic of solar panels supported above the ground level by portable lightweight support structures. Other embodiments can use a variety of different attachment mechanisms and/or fasteners for holding solar panels 108 together including rubber or plastic edge strips, or various kinds of fasteners such as Velcro® or cable ties.

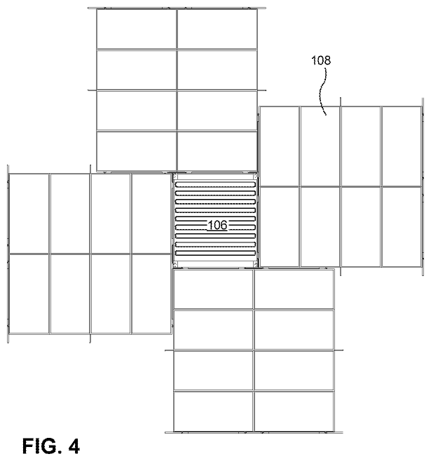

In the example shown, the array 102 may comprise a number of self-supporting subarrays all of the same height above the ground which can be arranged relative to one another to form an irregularly-shaped array. Different, independently supported solar panel subarrays can be joined together such as shown in FIG. 4. In the example shown, pairs of subarrays are joined together to provide 8-panel unitary structures supported by four legs on each side with the two inner legs crossing one another. Such 8-panel unitary structures can be joined together along parts of their lengths to provide an overall unitary planar array structure of any desired configuration.

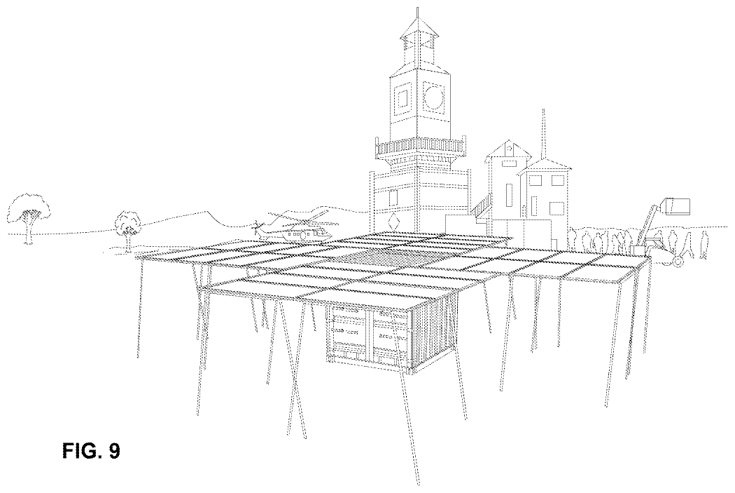

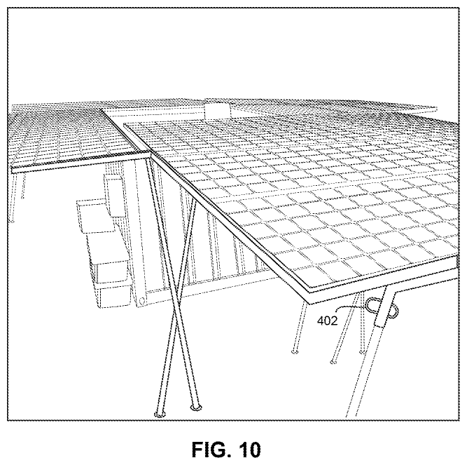

In the FIG. 4 example shown, one permutation of the array may be shaped as a four-leaf clover, with four subarrays extending in different directions (e.g., North, South, East and West) from a central point. A gap at or near the center of the overall array provides a ventilation space for housing 108. Thus, in this particular embodiment, no solar panel is mounted to a portion of an upper surface of housing 108. Rather, a portion of the top surface of housing 108 remains unobstructed so a ventilation stack can project from the housing top surface to above the level of the panel array. As shown in FIG. 9, other parts of the top surface of housing 108 can be used to support the solar panel array or may be kept free from solar panels. Its easier and faster to not put panels on the roof of the container. Roof-space is also desirable for communication equipment and water tanks when used to supply potable water. The fact that each set of panels is attached to the top of the container gives them great strength during strong winds. This arrangement also provides a particular space-efficient mosaic of solar panels that maximizes overall solar panel photosensitive area while minimizing the area taken up by the array, and allowing use of standard off-the-shelf solar panels that mechanically and electrically interconnect together. Other arrangements are also possible by reconfiguring the support structures to fit any desired regular or irregular deployment shape (e.g., a linear array, a pentagon, a hexagon, an octagon, etc.)

To disassemble each support structure for portability, the male tube ends are slidably disengaged from the female components of interlocking tube segments to provide a plurality of linear tube segments that can be bundled together in compact parallel bundles. The horizontal and vertical tube segments can have the same or similar lengths or they may have different lengths. They may be interchangeable or non-interchangeable.

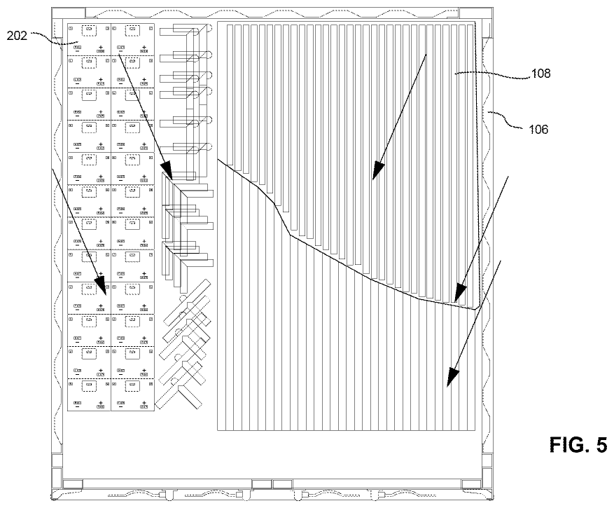

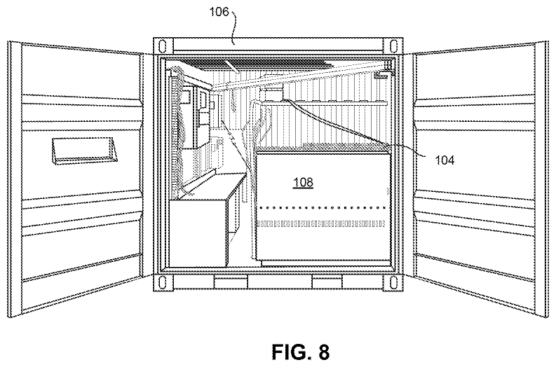

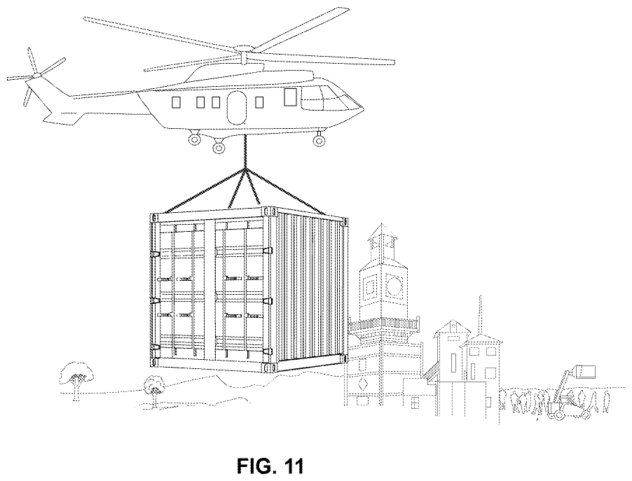

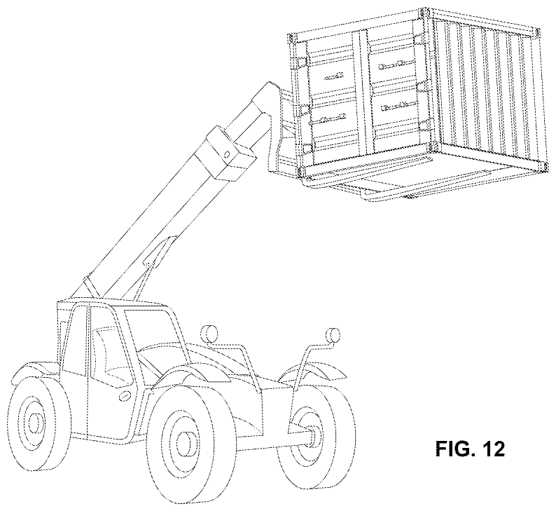

FIG. 5 is a cutaway view of the container with the roof missing so we can see inside. Housing 106 includes a bank of batteries 202 such as based on the Blue Planet Research energy storage technologies. These batteries 202 may be placed vertically with wiring on top. Housing 106 further stores vertically oriented solar panels 108 and support rods 104, as also shown in FIG. 8. The solar panels may be stored vertically and adjacent to one another (side by side). The pipe fittings 104 may also be provided in a compact arrangement for creating a PV support structure. Housing 106 may comprise a rugged metal or other material that protects sensitive components inside. Housing 106 may be of any desired size and shape, including one that can be moved about easily with a large forklift such as a Gradall (see FIG. 12) or dropped by helicopter (FIG. 11).

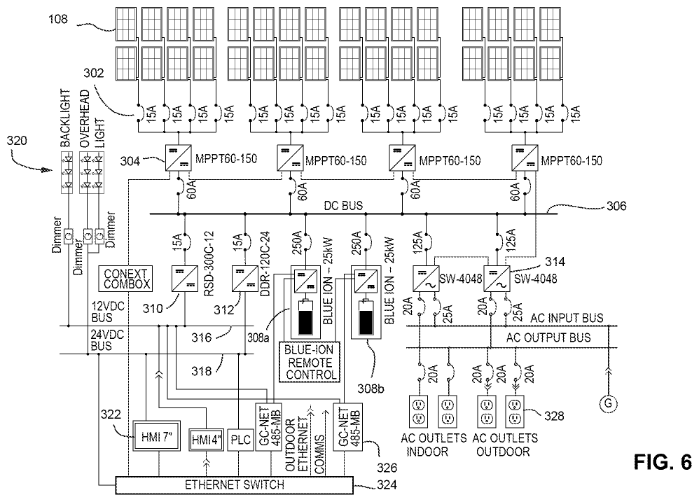

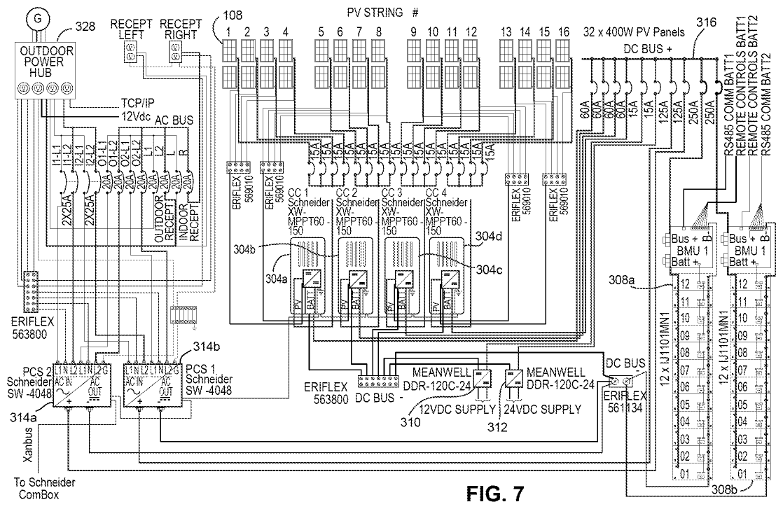

FIGS. 6 and 7 show schematic electrical diagrams of system 100. In the example shown, the arrays 108 are cross-connected in pairs to provide desired voltage/current, with pairs of such panels being connected through fuses 302 to conventional Conext™ MPPT 60-150 photovoltaic (PV) charge controllers 304 that track the maximum power point of a PV array to deliver the maximum available current for charging batteries. When charging, the MPPT 60-150 charge controller 304 regulates battery voltage and output current based on the amount of energy available from the PV array and state-of-charge of the battery. See Conext™ MPPT 60 150 Solar Charge Controller (865-1030-1) Installation and Owner's Guide 975-0400-01-01 Revision G (May 2015).

In the example shown in FIGS. 6 & 7, the charge controllers 304 provide their outputs to a DC bus 306. Various components are connected to DC bus 306, including:

battery bank(s) 308

A 48 VDC to 12 VDC converter 310

A 48 VDC to 24 VDC converter 312

A 48 VDC to 110 VAC AC converter(s) 314.

The DC-to-DC converters 310, 312 respectively supply DC power busses 316, 318 which in turn supply DC power to various components such as lights 320, displays 322, an ethernet switch 324, and a converter 326 that takes a serial modbus data stream and converts it to Modbus TCP Ethernet packets with software all packaged inside a simple cable.

The DC-to-AC converters 314 supply 110 VAC to conventional wall style outlets 328.

The battery bank 308 stores energy produced by panels 108 when the panels 108 are exposed to the sun, and supplies energy to DC bus 306 when the panels are not exposed to the sun (e.g., at night, during cloudy conditions, etc.).

All items cited above are incorporated by reference.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A portable solar power kit comprising:
a container for storing solar panels, support rods and a battery bank,
the support rods comprising horizontal support rods and more or less vertical support rods, the horizontal and more or less vertical support rods mating to provide u-shaped support structures for the solar panels,
wherein the solar panels are mechanically interconnected together at their respective edges.

2. The portable solar power kit of claim 1 wherein the solar panels are arrangeable in a four leaf clover configuration about the container, the four leaf clover arrangement leaving a top surface of the container exposed to the sun.

3. The kit of claim 1 wherein the battery bank is connectable be charged by the solar panels, and to supply power to a DC bus.

4. The kit of claim 1 wherein the solar panels are arrangeable in sub-arrays of 8 adjoining panels that interconnect together at their edges.

5. The kit of claim 1 wherein the container is configured to be lifted by a big fork lift.

6. The kit of claim 1 wherein the support rods are configured to interlock together with pins.

7. The kit of claim 1 wherein further including charge controllers for connection to the solar panels.

8. The kit of claim 1 wherein the solar panels comprise thirty-two 500-watt panels connectable in pairs.

9. A method of deploying a solar panel array comprising:
assembling a support structure comprising lightweight tubing;
interlocking plural solar panels together using interlocking mechanisms on respective edges panel to provide a substantially continuous expanse of light sensitive surface across the plural solar panels; and
supporting the interlocked plural panels with/on the lightweight tubing support structure.

10. A solar panel array comprising:
a support structure comprising lightweight tubing;
plural solar panels interlocked together using interlocking mechanisms on respective edges panel to provide a substantially continuous expanse of light sensitive surface across the plural solar panels; and
wherein the interlocked plural panels are supported with/on the lightweight tubing support structure
